(19) United States
(12) Patent Application Publication
(10) Pub. No.: US 2010/0214737 A1
(43) Pub. Date: Aug. 26, 2010

(54) Extendable heat-dissipating base set for notebook computers

(76) Inventor: Cheng Yu Huang, Taishan (TW)

Correspondence Address: Jackson Intellectual Property Group PLLC, 106 Starvale Lane, Shipman, VA, 22971, US

(21) Appl. No.: 11/898,487

(22) Filed: Sep. 12, 2007

(51) Int. Cl. G06F 1/20

(52) U.S. Cl. 361/679.48

(57) ABSTRACT

An extendable and retractable heat-dissipating base set for notebooks is disclosed. Wherein, heat-dissipating fans are provided on a bottom base, and an indicator, a switch and power terminals are provided on one side thereof; additionally, movable and extendable boards are provided on two ends of the base set such that the heat-dissipating fans provided within the bottom base can effectively dissipate heat for the notebooks placed thereon, and that the extendable boards can be extended when in use and retracted to reduce an overall size.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of the Invention

The present invention relates to a heat-dissipating base set for notebooks, having a movable and extendable board provided on two ends of the base set. The movable and extendable boards and heat-dissipating fans within the base set effectively dissipate the heat generated by the notebooks placed thereon. The extendable board provides extending and retracting functions so as to provide flexibility.

2. Background of the Invention

Portable computers, also known as notebooks, in general are characterized in their light weight and small size, and thus are also called “laptop computers” for they are suitable to be carried and used anywhere. However, limited by the size and structure of the notebooks, heat dissipation thereof is less effective than that of personal computers.

If used over a short time, notebooks can usually dissipate heat without problems; however, as use time increases, the notebooks can easily become overheated. In addition, since the easily overheated portion of the notebooks is located in the back of the notebooks that is closer to the hard drive, the CPU and the power source, overheating the notebooks can cause the hard drive or the CPU of the computer to crash and may even endanger the user. Thus, the overheating problem of the notebooks cannot be ignored by the suppliers.

In order to overcome the aforesaid heating problem of the notebooks, the suppliers came up with a “heat-dissipating base set” for the notebooks so as to assist heat dissipation. Nonetheless, the heat-dissipating base set for the notebooks in general needs to be customized to accommodate the size of the notebook. As a result, the heat-dissipating base set has a larger size in either two or three dimensions than the size of the notebook, causing some inconvenience when the notebook is placed on the table or when it is carried.

Due to the inconvenience of the heat-dissipating base set for the notebooks, the inventor previously developed an extendable and retractable heat-dissipating base set for notebooks as disclosed in the Taiwan Patent Application No. 093215665 as well as the U.S. patent application Ser. No. 11/039,794. The previous invention is further improved to an extendable heat-dissipating base set for notebooks as disclosed in the present invention, characterized in that a movable and extendable board is provided on two ends of the heat-dissipating base set. In addition to effectively dissipate heat for the notebooks placed above the base set, the extendable board provides extending and receiving functions such that it can be extended when in use and closed for storage, thereby decreasing the overall size.

The major difference between the present invention and the previous invention is that all components such as the fans and the circuit board are centrally provided within the base set in accordance with the present invention, and thus the manufacture and use thereof may be more appropriately done and consequently reduce failure.

### SUMMARY OF THE INVENTION

The present invention provides a heat-dissipating base set for notebooks. As shown in FIGS. 1 and 2, the present invention provides an extendable/retractable heat-dissipating base set for notebooks, including a bottom base 1, a cover 2, extendable boards 3, 4, heat-dissipating fans 11, 12, and an circuit board 13.

### DESCRIPTION OF THE DRAWINGS

FIG. 1 is a three-dimensional view of the present invention;

FIG. 2 is an exploded view of the main structure of the present invention;

FIG. 3 is a three-dimensional view of an embodiment in accordance with the present invention.

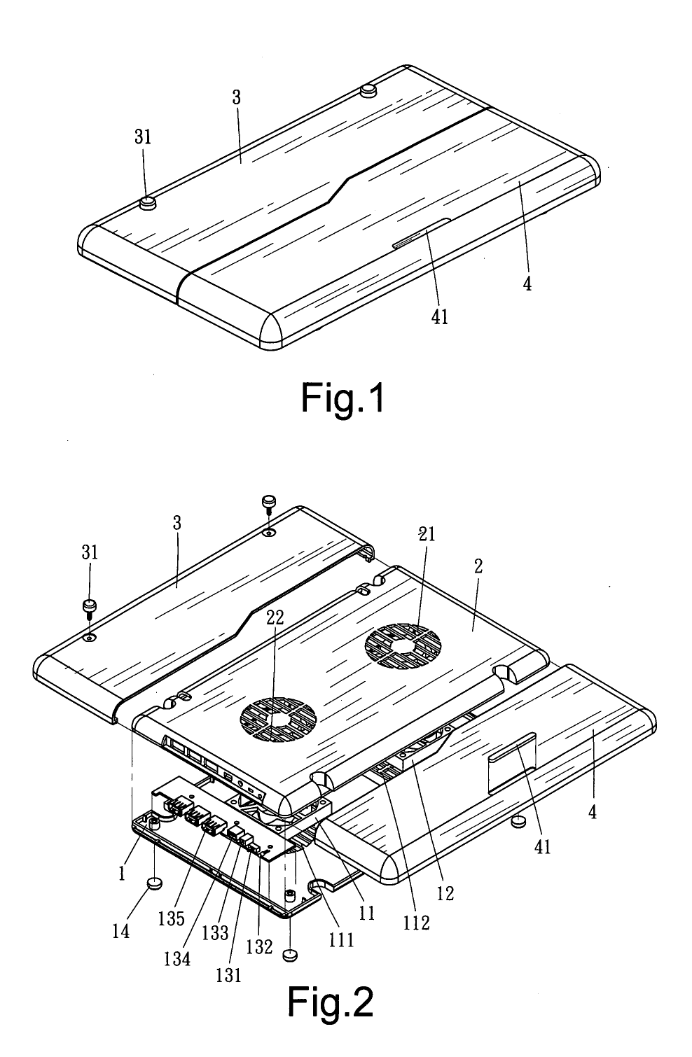

### DETAILED DESCRIPTION OF THE EMBODIMENTS

Refer to FIG. 2, the bottom base 1 is preserved with more than two ventilation holes 111, 112 thereon so as to correspond to the same number of heat-dissipating fans 11, 12. One side of the bottom base 1 is secured with the circuit board 13, having a switch 131, an indicator 132, and connecting terminals for a variety of power supplies 133, 134, 135.

On the back of the bottom base is provided with a plurality of stop blocks 14. Additionally, a cover is provided on the bottom base 1. The cover 2 is preserved with ventilation holes 21, 22 and a through hole 23, corresponding to the heat-dissipating fans 11, 12 and each of the components on the circuit board 13.

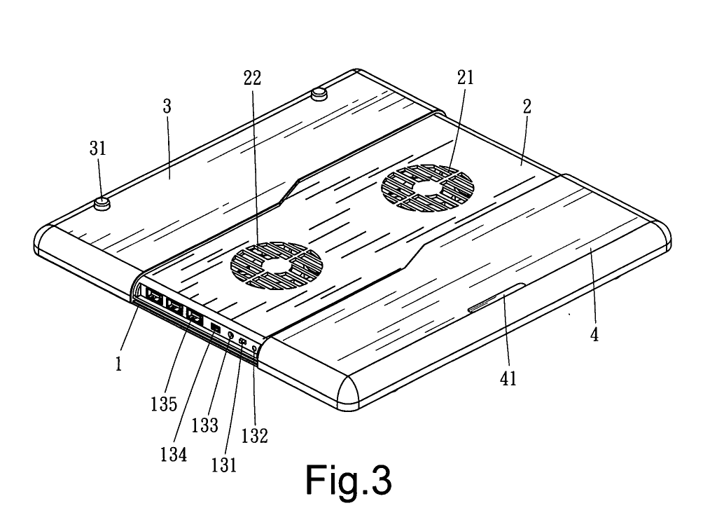

As shown in FIG. 3, movable and extendable boards 3, 4 are provided on two sides of the bottom base 1 and the cover 2, respectively. Therefore, when the extendable boards 3, 4 are extended for notebook use, the width of the heat-dissipating base set is increased, or when the extendable boards 3, 4 are retracted, the overall size is decreased.

Additionally, an adjustable pad 31 and a stop pad 41 are provided on the extendable boards 3, 4.

What is claimed is:

1. An extendable heat-dissipating base set for notebooks, comprising:
a bottom base 1, a cover 2, extendable boards 3, 4 heat-dissipating fans 11, 12 and a circuit board 13, said heat-dissipating base set characterized in that said heat-dissipating fans 11, 12, said circuit board 13 are centrally disposed within said heat-dissipating bottom base 1, and that movable and extendable boards 3, 4 are provided on two sides of said heat-dissipating bottom base 1 and said cover 2 such that in addition to effectively dissipate heat for said notebook placed on top of said heat-dissipating bottom base, said extendable boards can be extended when in use and received to reduce an overall size.
